(19) United States
(12) Patent Application Publication
(10) Pub. No.: US 2013/0199128 A1
(43) Pub. Date: Aug. 8, 2013

(54) Printer with Split Platen for Printing Web Material and Method

(71) Applicants: Gregory P. Rochon, York, PA (US); Thomas Glatfelter, Dover, PA (US)

(72) Inventors: Gregory P. Rochon, York, PA (US); Thomas Glatfelter, Dover, PA (US)

(21) Appl. No.: 13/367,763

(22) Filed: Feb. 7, 2012

(51) Int. Cl. B65B 63/00; B41J 2/325; B65B 9/20

(52) U.S. Cl. 53/131.5; 347/218

(57) ABSTRACT

A printer assembly for a form fill and seal machine prints indicia on the top web. The indicia are spaced apart on the top web.

### FIELD OF THE INVENTION

The invention relates to a printer with a platen assembly for printing a web and a related method.

### BACKGROUND OF THE INVENTION

Form fill and seal machines and other machines use printers to print indicia at spaced locations on web material used in the manufacture of packages and other articles. Conventional web printers use single-pass print heads for printing indicia on a portion of the web dwelled on a single platen and having a width determined by the width of the print head. The web is then fed downstream, dwelled again and the printer is actuated to print indicia on the web at a location spaced from the initial printed indicia. Sometimes a print head prints indicia at two locations on dwelled web on a single platen. These locations are within the width of the print head.

Dwelling of a web during single-pass printing of indicia spaced along the web slows production and limits the rate at which a form fill and seal machine, or other machines using the web, operate.

Thus, there is a need for an improved web printer and method where indicia is printed on a dwelled web at a number of locations spaced along the web distances greater than the width of the platen. Such a printer would speed the operation of the machine using the printed web and reduce the cost of printing by reducing the number of times the printer must be actuated to print the web.

### SUMMARY OF THE INVENTION

The invention is an improved printer assembly with a split platen and method. Web material is fed to a split platen and is positioned on a number of individual spaced platens, with web between the web on the platens led through a film feed slot between adjacent platens, away from the platens, around a registration roll and back to the slot to provide a length of web between the web on the platens. Single-pass movement of a print head along the platens prints indicia on the web on the platens at locations spaced apart along the length of the web a distance greater than the distance between the platens.

The platen assembly includes two or more split platens with a film feed slot and web registration roll between each pair of platens. In the disclosed embodiment, the platen assembly includes three split platens with two film slots and two web registration rolls. Web is pulled through the platen assembly. Frictional forces at the film feed slots are reduced by idler rollers at the slots.

The split platen assembly is used with a printer for a form fill and seal machine which makes sealed, filled packages from two thermoplastic webs. The split platen assembly permits printing of spaced indicia on three rows of container tops on a top web during one pass of a print head across the three platens. Conventional form fill and seal machines permit one-pass printing of a single row or two rows of indicia on a web on a single platen at one time. The disclosed improved platen assembly increases the speed of the form fill and seal machine by increasing the feed stroke of the machine and reducing operating cost.

### DESCRIPTION OF THE DRAWINGS

FIG. 1 is a side view of a form fill and seal machine using a printer assembly with a split platen assembly accordingly to the invention;

FIG. 2 is a view taken along line 2--2 of FIG. 1;

FIG. 3 is an end view of FIG. 1 taken in the direction of arrow 3;

FIG. 4 is a perspective view of a split platen assembly;

FIGS. 5 and 6 are transverse sectional views through the split platen assembly showing different positions;

FIG. 7 is a sectional view of the split platen assembly taken along line 7-7 of FIG. 6;

FIG. 8 is a view along line 8-8 of FIG. 6; and

FIG. 9 is a view illustrating a portion of the top web after one-pass printing.

### DESCRIPTION OF THE PREFERRED EMBODIMENT

Form fill and seal machine 10 makes filled and sealed packages from thermoplastic webs. The machine 10 includes frame 12 defining straight film feed path 14 extending along the frame from upstream end 16 of the frame to downstream end 18. Bottom web roll 20, mounted on the upstream end of the frame, supplies thermoplastic bottom web 22 which is fed along path 14. Top web roll 23 is mounted on frame 12 above path 14 and supplies thermoplastic top web 24, which is fed through printer assembly 42, around roller 26 and onto bottom web 22 on path 14. Roller 26 is located approximately halfway along path 14.

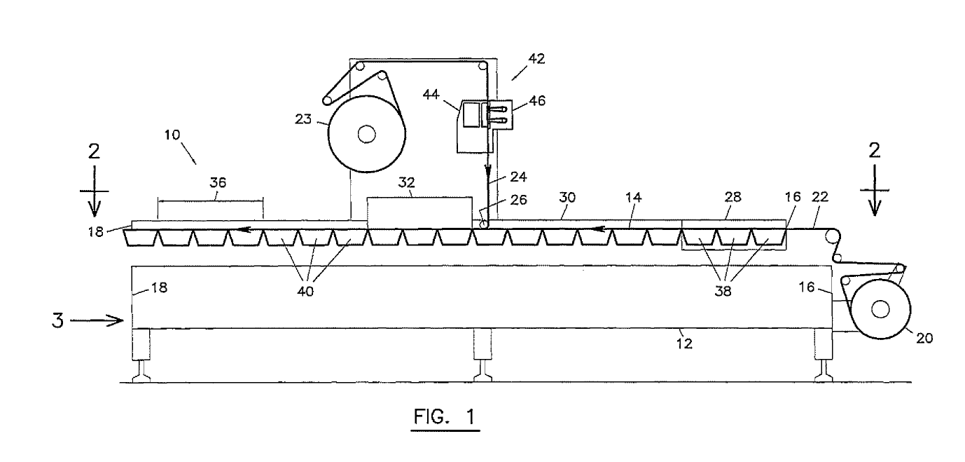

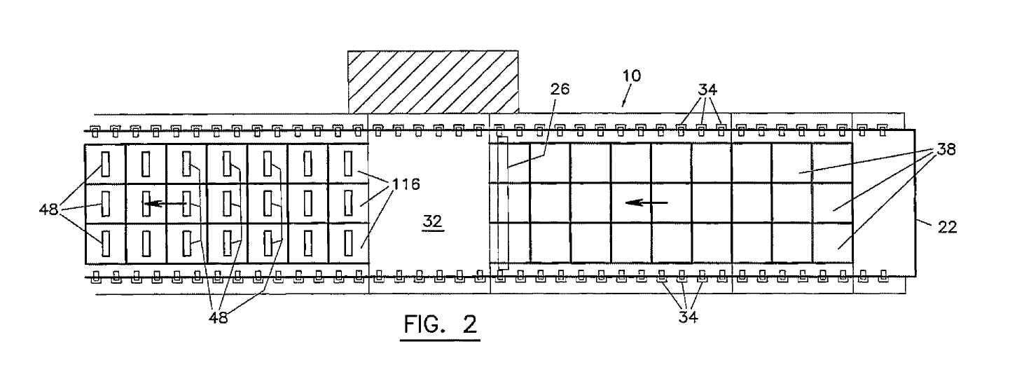

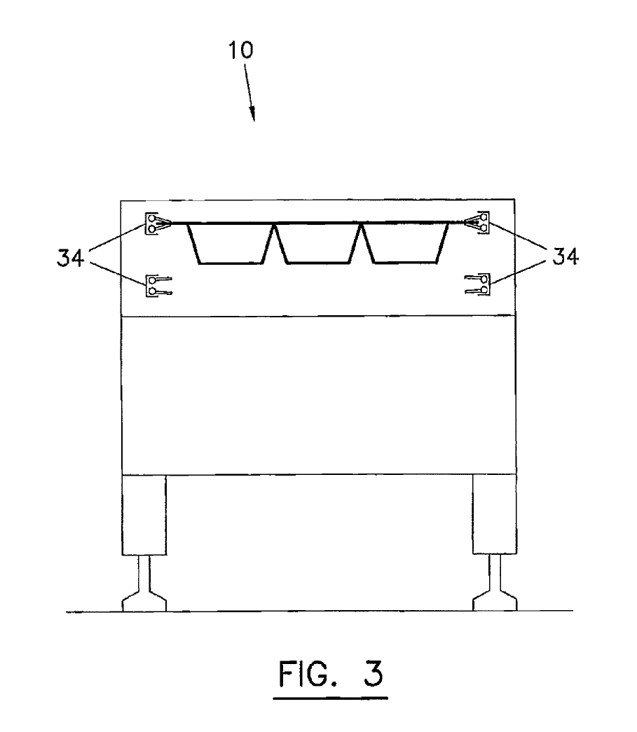

Container forming station 28 is located at the upstream end of path 14. Container loading station 30 is located between station and roller 26. Container sealing station 32 is located downstream from roller 26. The webs 22 and 24 are fed downstream along path 14 by two sets of web grippers 34 which are mounted on continuous chains on opposite sides of the bottom web and close to grip the outer edges of bottom web 22. The grippers are repeatedly moved downstream a feed distance 36 shown in FIG. 1 and are then dwelled to step feed of the webs along path 14. During dwelling of the grippers, the bottom web at forming station 28 is deformed downwardly to create three rows of three containers 38 or a total of nine containers 38. During the next feed stroke, the newly formed rows of containers are fed to loading station 30 and are dwelled and filled with articles to be stored in the packages made by machine 10.

During the next feed cycle, the three rows of filled containers 38 are fed under the top web 24, and the top and bottom webs are fed into sealing station 32 where printed top web is bonded to the three rows of containers in the bottom web to form nine filled and sealed packages 40.

Printer assembly 42 is mounted on frame 12 above feed path 14. Top web 24 is pulled through assembly 42. During dwell of the webs, assembly 42 prints three rows of indicia 48 on the portion of web 24 which closes the filled containers 38 to form packages 40.

Printer assembly 42 includes printer 44 for one-pass printing of indicia 48 on the top surface of web 24, and platen assembly 46 on the opposite side of top web 24 from printer 44 for supporting the top web on split platens during printing. Indicia 48 may identify the contents of the package, the date of packaging and/or the name and address of the manufacturer. The indicia may include artwork and convey other information, as desired.

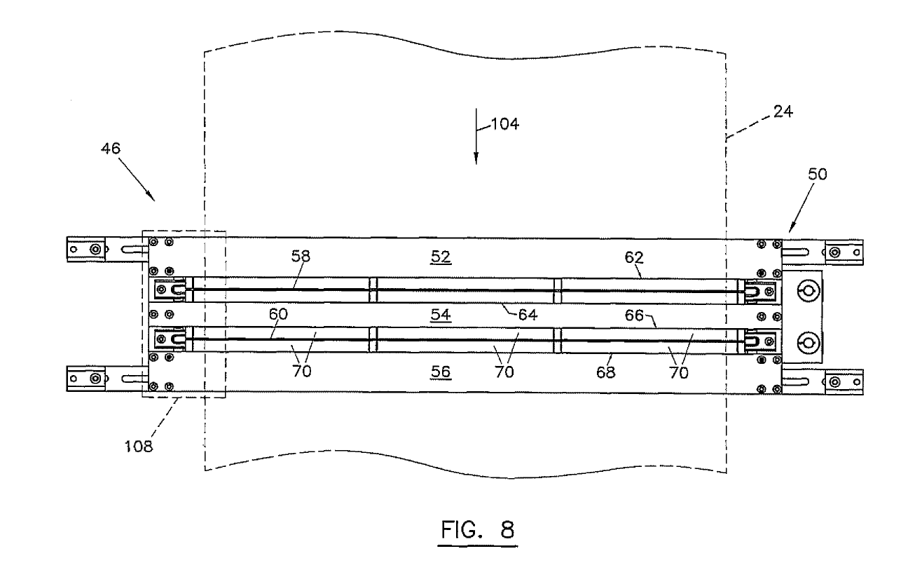

Platen assembly 46 includes body 50 mounted on frame 12 and having three spaced apart, flat platens 52, 54 and 56. The platens extend across the width of top web 24 as shown in FIG. 8 and face printer 44. Film feed slot 58 separates platens 52 and 54. Film feed slot 60 separates platens 54 and 56. A long, small diameter idler roller 62 is mounted on platen 52 adjacent slot 58. A like idler roller 64 is mounted on platen 54 adjacent slot 58, across the slot from roller 62. Likewise, long, thin idler roller 66 is mounted on platen 54 adjacent slot 60, and long, thin idler roller 68 is mounted on platen 56 adjacent slot 60, across the slot from roller 66. The idler rollers facilitate feed of top web 24 into and back through slots 58 and 60 by reducing friction.

Each roller 62, 64, 66 and 68 includes three segments 70 secured together by pins 72 and secured to body 50 by pins 74 at the ends of the rollers. Support bearings 76 are mounted on pins 72 and 74 and are connected to body 50 by arms 78. The bearings prevent bending of the rollers when the top web is pulled through the platen assembly.

Platen assembly 46 includes two web registration rolls 80 and 82 located to the side of platens 52, 54 and 56 away from the printer assembly. Roll 80 is behind slot 58. Roll 82 is behind slot 60. End walls 84 and 86 on body 50 extend away from the platens. Each wall has two slots 88 aligned with the film feed slots 58 and 60.

Each roll 80, 82 includes a central shaft 90 which rotatably supports the roll. The ends of shafts 90 extend into slots 88 in walls 84 and 86. The shafts 90 extend beyond wall 86 and are connected to slide blocks 92 outside of wall 86. Threaded rings 94 are mounted on blocks 92 and engage threaded shafts 96 rotatably mounted on brackets 98 and extending through blocks 92. Pinion gears 100 are mounted on the ends of shafts 90 between the rolls 80, 82 and walls 84 and 86. The gears 100 engage racks 102 on walls 84 and 86.

Knurled knobs 104 on shafts 96 above the outermost bracket 98 are used to rotate the shafts 96 and move the rolls 80, 82 toward and away from the platens to adjust the length of the top web between the platens during one-stroke printing of web on the three platens by printer 44.

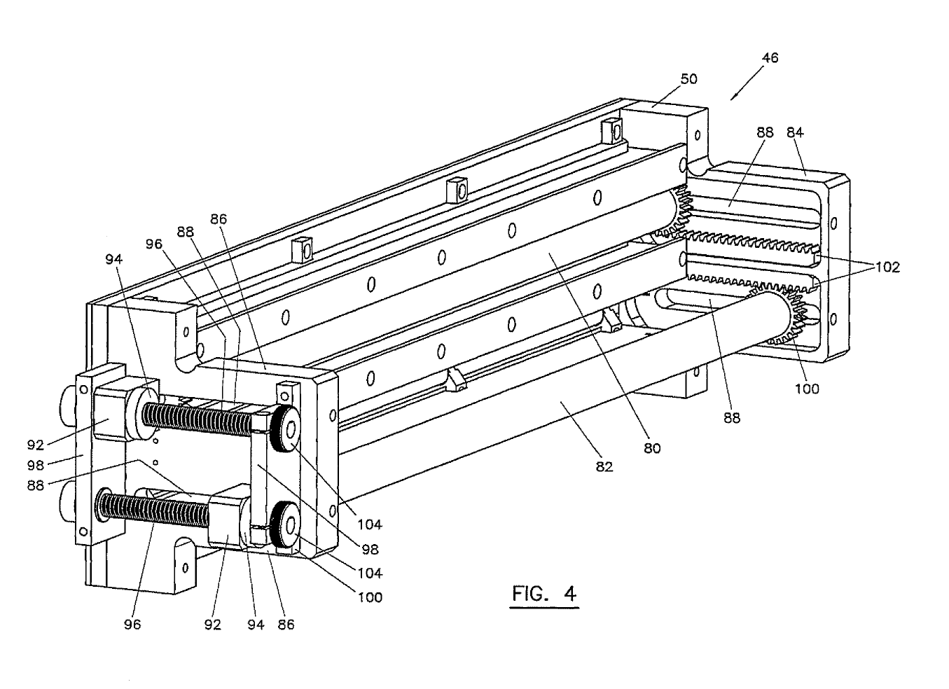

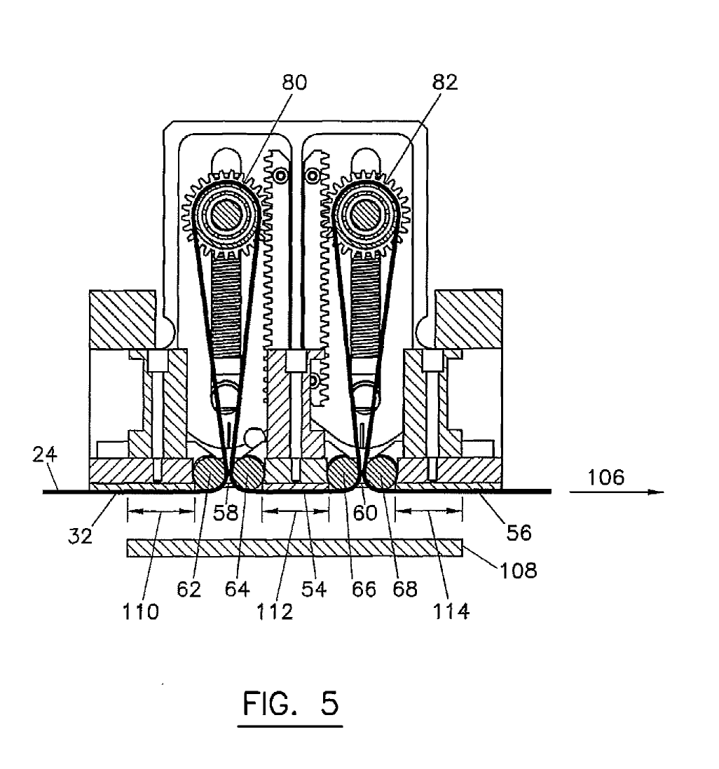

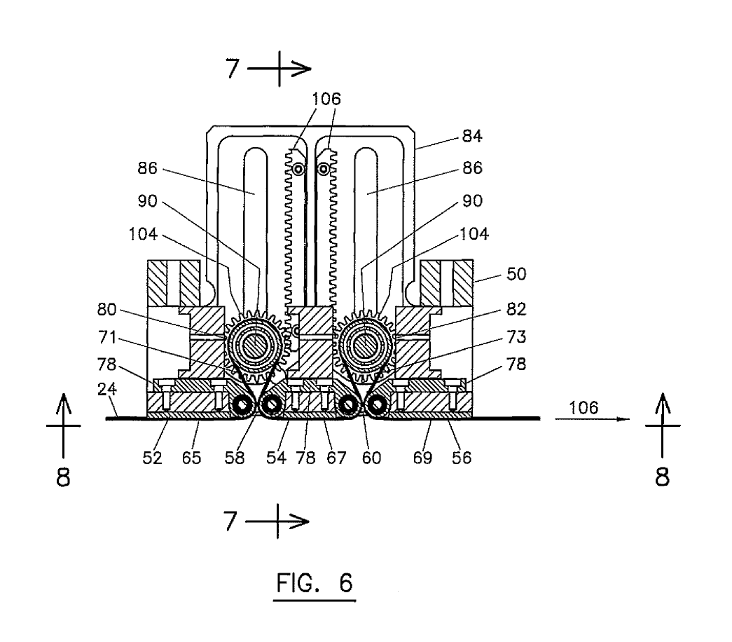

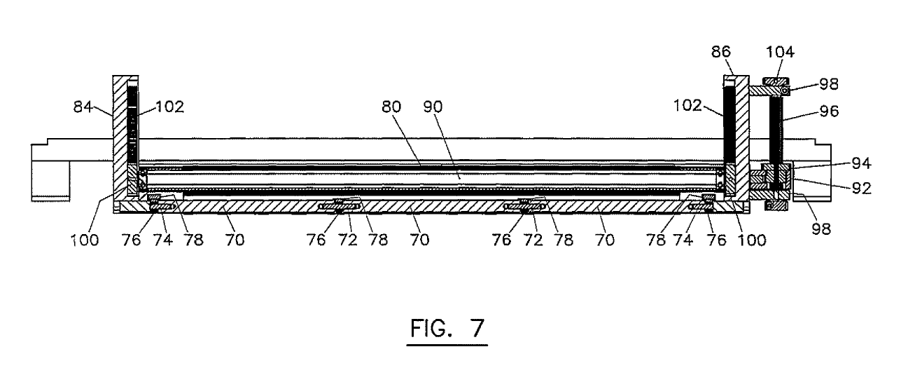

FIG. 4 illustrates registration roll 80 positioned adjacent to the platens to minimize the length of the top web between platens 52 and 54 during printing. Roll 82 is shown in a retracted position to maximize the length of the top web between platens 54 and 56 during printing. FIG. 4 is representational. Normally, both rolls 80 and 82 are positioned the same distance away from the platens so that the spacing between the three print fields on the top web is uniform. See FIGS. 5 and 6.

The top web 24 is fed through the platen assembly 46 in the direction of arrow 106 as shown in FIGS. 5 and 6. The web is fed over platen 52, around idler roller 62 and through slot 58, around roll 80, around idler roller 64 and back through slot 58. From slot 58, the top web is fed over platen 54, around idler roller 66, through slot 60, around roll 82, around idler roller 68, back through slot 60 and over platen 56. The portions 65, 67 and 69 of the top web on platens 52, 54 and 56 are spaced apart along the top web by the U-shaped portions 71 and 73 of the top web extending from the platens through the slots and around rolls 80 and 82 and back from the rolls to the slots. The length of each portion 73 is greater than the width of the slots 58 and 60 adjacent the portion.

FIG. 8 illustrates the three platens 52, 54 and 56 and shows print head 108 in printer 44, illustrated in FIG. 1, in dashed lines. The print head is in its home position. During printing, the head moves along the three platens and across the web. The web is dwelled on the platens during printing. The print head makes a single pass along the three platens 52, 54 and 56 to print the web on the platens and then returns to the home position. During single-pass printing, a row of three indicia 48 is printed on the top web 24 portions on each of the three platens.

FIG. 5 illustrates the widths 110, 112 and 114 of the three printed indicia 48 on platens 52, 54 and 56. Printer 44 prints a row of three indicia on the web on each platen. The three rows of indicia 48 on the web on the three platens are printed in one pass of print head 108.

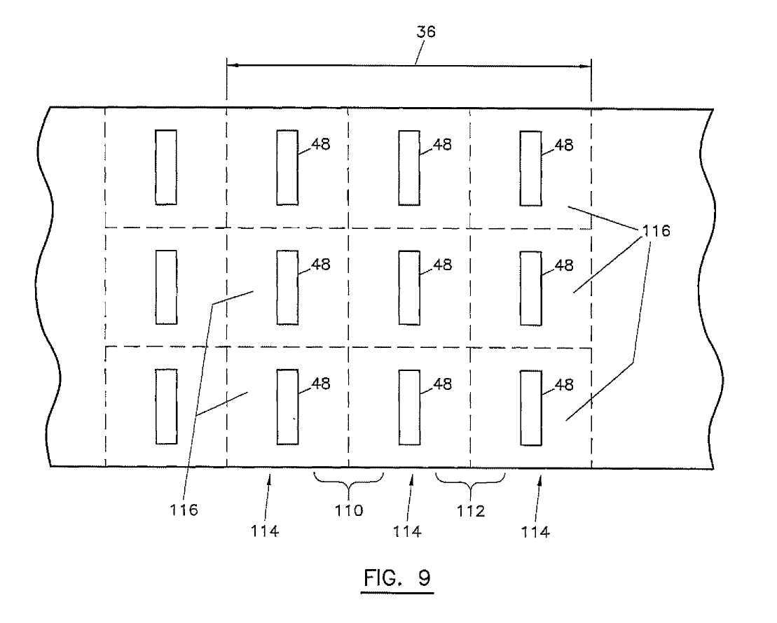

FIG. 9 illustrates the nine indicia 48 printed on top web 24 by one pass of print head 108 across the web after the web has been pulled from assembly 46 and straightened. During printing, the portions of top web 24 indicated by brackets 110 and 112 are U-shaped and are wrapped around rolls 80 and 82 away from the platens. After downstream feeding of the top web, the U-shaped web portions 71 and 73 are straightened, as indicated by brackets 110 and 112, and extend along the length of the web to separate the printed indicia in three like and spaced apart rows 114 on covers 116 for nine spaced containers 38.

Printing of a top web using a printer with a multi-platen support for the web permits one-pass printing of indicia spaced apart on the web a distance greater than permitted using conventional printers with single platens where the width of the printing is limited by the width of the printer head. As shown in FIG. 8, print head 108 extends across the three platens 52, 54 and 56 so that the print head 108 prints the top web 24 supported on the platens in a single pass across the web. The print head is programmed to print three identical indicia 48 on the web on each platen.

Simultaneous printing of indicia at spaced locations along the length of a web accelerates operation of machine 10 because it is possible to print indicia for covers 116 for three rows of containers spaced along the bottom web at one time. The web feed stroke 36 of the machine can be increased to three rows of top covers. The distance along the web between indicia printed in one stroke of the printer is not limited by the width of the print head.

Platen assembly 46 includes three spaced platens. If desired, the platen assembly may include two spaced platens or more than three spaced platens with slots between adjacent platens and a registration roll at each slot. Idler rollers are necessary to reduce friction when web is pulled through the platen assembly. Bearings 76 and support arms 78 prevent deflection of the idler rollers during feeding of the top film.

Print head 108 may be a conventional thermal print head. Other types of printers, including rotary offset printers, may be used to print the top web on platens 52, 54 and 56. If desired, the printer may print web on the platens by movement across the platens and along the length of the web.

The platen assembly 46 prints top web for forming covers for sealed packages 40 made by form fill and seal machine 10. The assembly 46 may be used to print spaced print fields on webs used in other applications where the print fields are spaced along the web a distance greater than the width of the print head or the space between platens so that the utility of the platen assembly is not limited to printing top webs for form fill and seal machines.

Also, the platen assembly may be used to print on webs other than thermoplastic webs. For instance, the assembly may be used to print spaced fields on paper, metal or woven webs. In some cases, where the web material is sufficiently strong and has a low-friction finish on the side of the web which is not printed, the idler rollers 62-68 may be replaced by curved edges of the platens at slots 58 and 60. The edges may be coated with low-friction material, such as a low-friction thermoplastic material, to reduce friction during feeding of the web through the slots.

1. A printer assembly for printing indicia on spaced apart portions of an elongate web; the printer assembly comprising a platen assembly including two spaced platens and an opening between the platens; a printer located on one side of the platen assembly, the printer including a one-pass print head movable to print web on the platens; a roll located on the other side of the platens from the printer; and a web including a first web portion positioned on one platen and facing the print head, a second web portion positioned on the second platen and facing the print head, and a third web portion between the first and second portions, the third web portion extending from the first portion through the opening, around the roll, back through the opening and to the second portion, wherein one-pass movement of the print head across the platens prints indicia on the first and second portions of the web with the third portion of the web between the indicia.

2. The printer assembly as in claim 1 wherein the opening is a slot.

3. The printer assembly as in claim 2 wherein the third portion of the web includes a reverse bend at the roll.

4. The printer assembly as in claim 1 wherein the roll has a first position adjacent the opening and a second position away from the opening, wherein the spacing between the indicia on the web is greater when the roll is in the second position than when the roll is in the first position.

5. The printer assembly as in claim 4 including an adjustable drive to move the roll between the first position and the second position.

6. The printer assembly as in claim 5 wherein the drive includes a rack on the platen assembly and a pinion on the roll.

7. The printer assembly as in claim 1 wherein the print head is a thermal print head.

8. The printer assembly as in claim 1 including a web idler roller at each side of the opening.

9. The printer assembly as in claim 8 including a number of bearings spaced along each idler roller and an arm securing each bearing on the printer assembly.

10. The printer assembly as in claim 1 wherein the web is formed of thermoplastic material.

11. The printer assembly as in claim 1 wherein during printing, the print head moves across the web.

12. A form fill and seal machine for making filled packages from a bottom web and a top web, the machine including a feed path, a forming station on the path, a loading station on the path downstream from the forming station, and a sealing station on the path downstream from the loading station, a web feeder for moving the bottom web along the path and past said stations and for moving the top web onto the path between the loading station and the sealing station, and a printer assembly as in claim 1, the top web extending through the printer assembly upstream from the sealing station, said top web forming said first, second and third web portions, wherein top web with indicia printed by the printer assembly forms tops of the sealed containers.

13. A printer assembly for printing indicia on spaced apart portions of a continuous web, the printer assembly including two platens, said platens spaced apart a distance, a one-pass print head on one side of the platens for printing web on the platens; and a web including a first web portion on the first platen, a second web portion on the second platen and a third web portion between said first and second web portions, the third web portion having a length along the web greater than the distance between the platens so that the first and second web portions are spaced apart by such distance along the web, wherein one-pass movement of the print head prints indicia on the first and second web portions on the platens, said indicia separated along the web by the third web portion.

14. The printer assembly as in claim 13 wherein said third web portion includes a reverse bend.

15. The printer assembly as in claim 14 including a web guide member on the side of the platens away from the print head, the web guide member inside the reverse bend in the third web portion extending around said web guide member.

16. The printer assembly as in claim 15 wherein said web guide member comprises a roll.

17. The printer assembly as in claim 13 wherein said print head is moved across the web during printing.

18. The method of printing indicia on spaced portions of an elongate web using a one-pass printer assembly of the type including two spaced apart platens and a one-pass print head located on one side of the platens, comprising the steps of:
a) positioning a web in the printer assembly with a first web portion on a first platen, a second web portion on a second platen and a third web portion between the first and second web portions, the third web portion having a length greater than the spacing between the platens; and
b) moving the print head across the platens in a single pass to print indicia on the first and second portions of the web, the indicia spaced apart on the web by the third portion.

19. The method of claim 18 including the step of:
c) feeding the web through an opening between the platens to position the third portion of the web away from the platens during printing of the first and second web portions.

20. The method of claim 19 including the step of:
d) feeding a U-shaped part of the third web portion around a roll away from the platens.
